(19) United States
(12) Patent Application Publication
(10) Pub. No.: US 2004/0027373 A1
(43) Pub. Date: Feb. 12, 2004

(54) Linked screen demonstration program for computer application programs

(76) Inventors: Bryan Joseph Jacquot, Windsor, CO (US); Donny P. Cordova, Albuquerque, NM (US)

Correspondence Address: HEWLETT-PACKARD COMPANY, Intellectual Property Administration, P.O. Box 272400, Fort Collins, CO, 80527-2400, US

(21) Appl. No.: 10/214,007

(22) Filed: Aug. 7, 2002

(51) Int. Cl. G09G 5/00

(52) U.S. Cl. 345/730

(57) ABSTRACT

A computer operable method for creating a demonstration program. In representative embodiments, wherein the demonstration program is executable on a first computer, a computer operable method is disclosed which comprises initiating an application program on a second computer. On a monitor connected to the second computer, at least two images of a graphical user interface created by the application program are displayed, wherein one of the images is selectable from the other image for display on the monitor. At least two images of the graphical user interface displayed are captured. An image map for the image of the graphical user interface from which the other image of the graphical user interface is selectable is created, wherein the image map specifies the linkage between the images of the graphical user interface. The captured images of the graphical user interface and the image map are linked to form the demonstration program, wherein the demonstration program mirrors the functional selectivity of one image of the graphical user interface by another in the application program.

### FIELD OF THE INVENTION

The present invention relates generally to computer application programs and, more particularly, to demonstration programs for computer application programs.

### BACKGROUND OF THE INVENTION

Demonstrations of program operation are used by the developer of an application software program to market and sell his product. As computer software programs have become more complex and more expensive, providing an effective, efficient means for demonstrating the use and features of these programs has become more and more important. While the end user could be provided a partially or even fully functional application program for him to evaluate, this alternative has numerous drawbacks. In particular, it is impractical for complex programs intended for operation on large, expensive platforms. Due to performance and market constraints, some software programs are executable only on limited sets of computer systems. As an example, Hewlett-Packard's “Partition Manager” currently runs on only their high-end servers that support hardware partitions, such as the very expensive Superdome family of computers. Thus, in order to provide a potential customer with a demonstration of this software product, a Superdome computer would be required. As the cost of one of these systems can easily exceed a million dollars, a hands on demonstration of the actual product becomes impractical except in a limited number of cases.

Several techniques designed especially for demonstrating those application programs which are based upon graphical user interfaces (GUI) have been developed. The simplest and most common alternative for providing graphical user interface demonstrations is the display of static copies of preselected screen displays of the application program. Such sets of static screen displays provide the end user the ability to view individual, key screens of the product. There is, however, no mechanism for the user to interact with the static screen displayed and, thus, to provide real-time feedback to him regarding any action that he might wish to take. The user can be led through the program, but he cannot interact with it.

An alternative solution is to use a screen recording utility to record the operation of the graphical user interface, and then play-back the resulting movie when needed. This approach, however, still lacks flexibility from the user's standpoint. He again has no mechanism for interacting with the displayed screens. He merely can watch as the movie transitions from one display screen to the next.

Another solution is to provide a full-scale or partially working product for demonstration purposes that can be operated on a variety of platforms. Although this approach gives the user maximum flexibility, it can be much more expensive than the solutions discussed above, both in setup costs, and in the dedicated ongoing resources required to provide a real product for demonstration purposes. Depending upon the platforms required, the cost of such an approach could be on the order of millions of dollars for the hardware alone. Furthermore, this approach generally requires the software be installed on the user's system, which can be viewed as an intrusive operation for simply demonstrating software.

And still another solution is to provide a simulation of the product which can be run on a smaller machine and/or a different operating system than that for which it is intended. While the required investment in hardware is not as great as providing a working product, a large time investment is required to setup and support such a system.

### SUMMARY OF THE INVENTION

In representative embodiments, a computer operable method for creating a demonstration program, wherein the demonstration program is executable on a first computer, is disclosed which comprises initiating the application program on a second computer. On a monitor connected to the second computer, at least two images of a graphical user interface created by the application program are displayed, wherein one of the images is selectable from the other image for display on the monitor. At least two images of the graphical user interface displayed are captured. An image map for the image of the graphical user interface from which the other image of the graphical user interface is selectable is created, wherein the image map specifies the linkage between the images of the graphical user interface. The captured images of the graphical user interface and the image map are linked to form the demonstration program, wherein the demonstration program mirrors the functional selectivity of one image of the graphical user interface by another in the application program. In other representative embodiments, a program storage medium readable by a computer, embodying a software program of instructions executable by the computer for creating a demonstration program for an application program, wherein the demonstration program is executable on a first computer is disclosed. The program comprises logic for initiating the application program on a second computer and logic, for displaying, on a monitor connected to the second computer, at least two images of a graphical user interface created by the application program, wherein one of the images is selectable from the other image for display on the monitor. The program further comprises logic for capturing at least two images of the graphical user interface displayed, logic for creating an image map for the image of the graphical user interface from which the other image of the graphical user interface is selectable, wherein the image map specifies the linkage between the images of the graphical user interface, and logic for linking the images of the graphical user interface and the image map to form the demonstration program, wherein the demonstration program mirrors the functional selectivity of one image of the graphical user interface by another in the application program.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements and:

FIG. 1 is a drawing of a standalone demonstration system as described in various representative embodiments consistent with the teachings of the invention.

FIG. 2 is a drawing of an application system as described in various representative embodiments consistent with the teachings of the invention.

FIG. 3 is a drawing of an online demonstration system as described in various representative embodiments consistent with the teachings of the invention.

FIG. 4 is a drawing of an example of a graphical user interface as displayed on the application system of FIG. 2.

FIG. 5 is a drawing illustrating the contents of the markup files with linking image maps and image files as described in various representative embodiments consistent with the teachings of the invention.

FIG. 6 is a drawing of a user program interface as described in various representative embodiments consistent with the teachings of the invention.

FIG. 7 is an illustrative flow chart of a method for creating a demonstration program as described in various representative embodiments consistent with the teachings of the invention.

### DETAILED DESCRIPTION OF THE PREFERRED EMBODIMENTS

As shown in the drawings for purposes of illustration, the present patent document relates to novel techniques for demonstrating the use of a computer application program. In representative embodiments, inexpensive, platform portable demonstration techniques are disclosed. Embodiments of such demonstration techniques, enable the potential customer to interact with the graphical user interface (GUI) of the demonstration program via either a web browser or a computer system of more limited performance than that required for the application program itself. Thus, the systems necessary to execute the demonstration program typically cost less than that on which the application program itself executes. Additionally, a user of the demonstration need not install any software, or perform any system configuration to utilize the software demonstration. This is especially important for applications that were designed to run in a specific environment that is costly or difficult to setup. For example, HP's Partition Manager application was designed to execute only on expensive hardware servers in a X Windows/Motif environment. Furthermore, the application will only execute on the HP-UX operating system. This demonstration technique allows a user to navigate the screens of the GUI interface using a common and standard application, such as a web browser, on any common computer hardware and operating system.

In the following detailed description and in the several figures of the drawings, like elements are identified with like reference numerals.

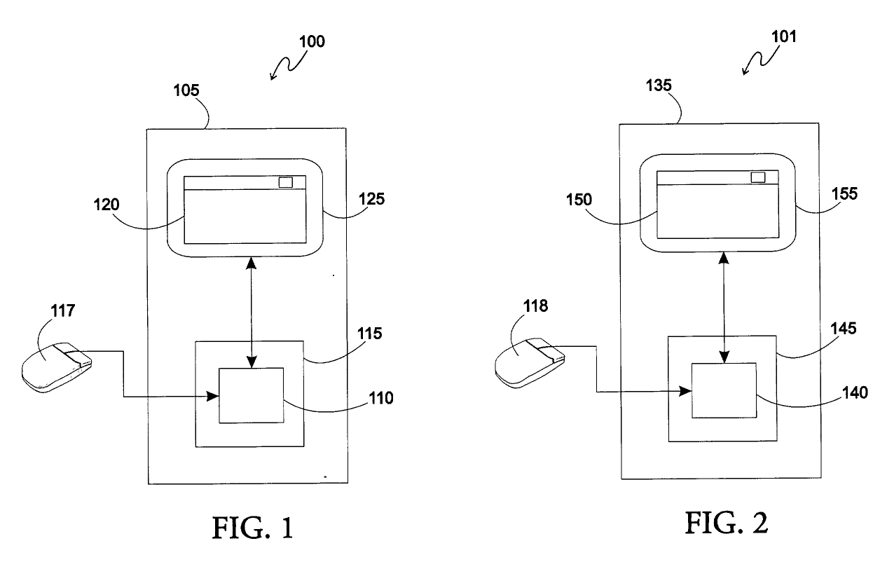

FIG. 1 is a drawing of a standalone demonstration system 100 as described in various representative embodiments consistent with the teachings of the invention. In the representative embodiment of FIG. 1, the standalone demonstration system 100 comprises a first computer 105 on which a demonstration program 110 is executable. The demonstration program 110 is stored in a first memory 115, also referred to herein as a program storage medium 115. The first computer 105 is also referred to herein as the demonstration computer 105. A first graphical user interface 120, also referred to herein as a first interface 120 and as a demonstration program graphical user interface 120, is displayed on a first computer monitor 125 of the first computer 105. The demonstration program 110 could be controlled via key strokes on a keyboard not shown in the figures, a pointing device 117, or the like. The pointing device 117 could be a computer mouse 117, a light pen 117, a track ball 117, a touch screen 117, or similar device.

FIG. 2 is a drawing of an application system 101 as described in various representative embodiments consistent with the teachings of the invention. In FIG. 2, the application system 101 comprises a second computer 135 on which an application program 140 is executable. The application program 140 is stored in a second memory 145. The second computer 135 is also referred to herein as the application computer 135. A second graphical user interface 150, also referred to herein as a second interface 150 and as an application program graphical user interface 150, is displayed on a second computer monitor 155 of the second computer 135. The application program 140 could be controlled via key strokes on a keyboard not shown in the figures, a pointing device 118, or the like. The pointing device 118 could be a computer mouse 118, a light pen 118, a track ball 118, a touch screen 118, or similar device. The application program 140 is typically inoperable on the first computer 105 on which the demonstration program 110 is executable

The demonstration program 110 typically has reduced functionality when compared to the application program 140. This reduced functionality can, for example, include slower operating speed, smaller memory requirements, and limited functionality with respect to the application program 140 which it is designed to demonstrate. In addition, the demonstration program 110 may be executable on platforms, hardware and/or operating system, that differ from that on which the application program 140 is executable. The demonstration program 110 does, however, provide a representation of the functioning of the application program 140 even though typically more limited than that the application program 140 itself. As will be disclosed in the following, the application computer 135 provides a means by which the demonstration program 110 is created.

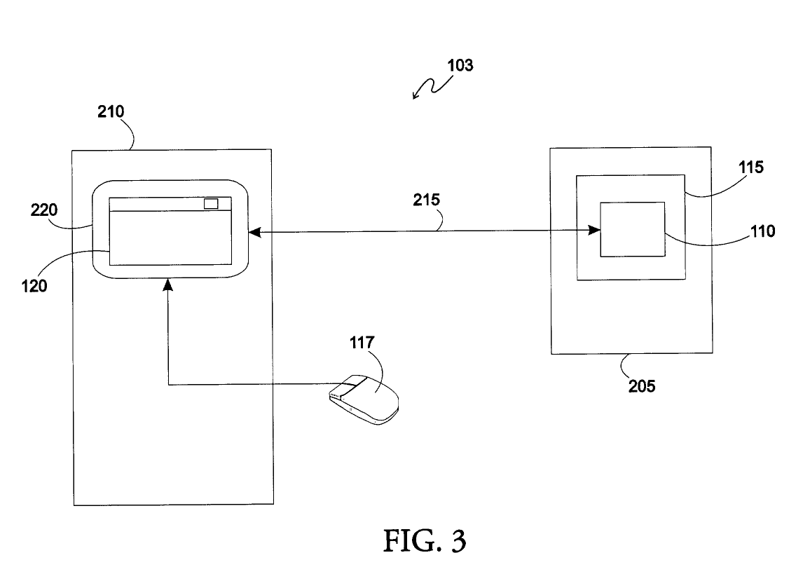

FIG. 3 is a drawing of an online demonstration system 103 as described in various representative embodiments consistent with the teachings of the invention. In the representative embodiment of FIG. 3, the online demonstration system 103 comprises a central computer 205, also referred to herein as a server computer 205, on which the demonstration program 110 is executable. The server computer 205 is connected to a local computer 210, also referred to herein as a client computer 210, via communication link 215. The communication link 215 could be, for example, a network 215, the Internet 215, the client computer's 210 loopback interface 215, or the like. The communication link 215 could also be a commercial or private telephone system 215 which use modems, for example, for interfacing with the server and client computers 205,210. The demonstration program 110, resides in the first memory 115 of the server computer 205. The demonstration program graphical user interface 120 is displayed on the client computer monitor 220 of the client computer 210. The demonstration program 110 could be controlled via key strokes on a keyboard not shown in the figures, a pointing device 117, or the like. The pointing device 117 could be a computer mouse 117, a light pen 117, a track ball 117, a touch screen 117, or similar device.

Instead of running the demonstration program 110 online as described in FIG. 3, a file comprising the demonstration program 110 could be downloaded from the server computer 205 to the client computer 210 via the communication link 215 shown. This file could be in either compressed for uncompressed format. If in compressed format, as for example that of the common “zip file”, the file would need to be expanded on the client computer 210 prior to use. Once the file is ready for use, the file could be run in the stand alone mode as describe with respect to FIG. 1.

For the application program graphical interface 150 of FIG. 2 and for the demonstration program graphical image user interface 120 of both the stand-alone embodiment of FIG. 1 and the client-server embodiment of FIG. 3, the graphic user interfaces could be created, for example, by using the hypertext markup language (HTML) as discussed in the following. HTML is a set of symbols or codes inserted in a file which is typically intended for display by an Internet browser. As previously stated, typically the computers used for running the demonstration program 110, for example, the demonstration computer 105 of FIG. 1 and the server computer 205 and the client computer 210 of FIG. 3, are less expensive and powerful than the application computer 135 of FIG. 2 which is used to run the application program 140 itself.

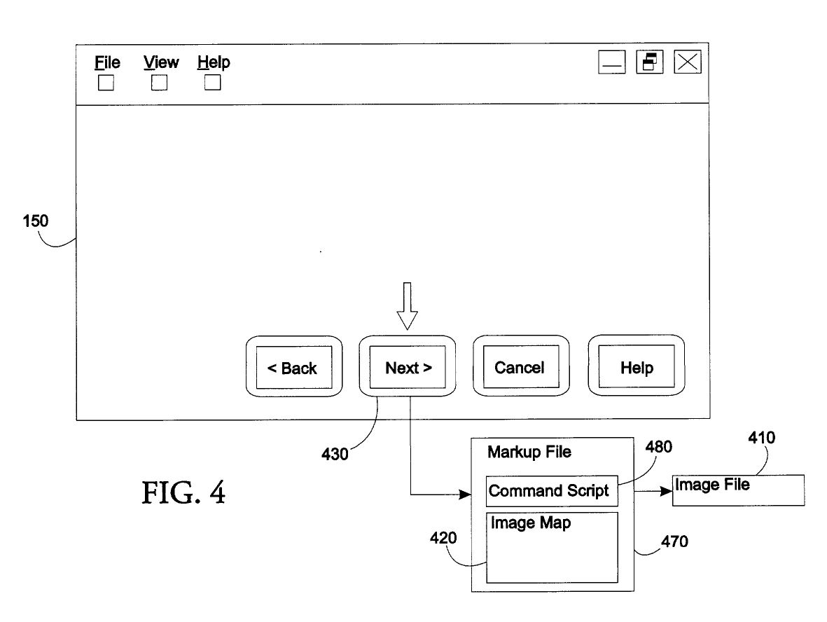

FIG. 4 is a drawing of an example of a graphical user interface 150 as displayed on the application system 140 of FIG. 2. As the application program 140 is executed, the application program 140 steps through various images of the graphical user interface 150 only one of which is shown in FIG. 4. As a step in the creation of the demonstration program 110, images of the graphical user interface 150 displayed by the application program 140, which the demonstration program 110 developer chooses, are saved as graphical user interface image files 410, which are also referred to herein as image files 410, for later use in the demonstration program 110. So as to limit the complexity, size, and development cost of the demonstration program 110, the developer usually limits the number of choices which the demonstration program 110 user is permitted for each image of the application program graphical user interface 150 displayed. The stored graphical user interface image files 410, which are often referred to as screen shots or screen images, form the core of the demonstration program 110.

Graphical user interface (GUI) demonstration programs 110 can be developed using image files 410 which are referenced in markup files 470, also referred to herein as hypertext markup language files 470 and as HTML files 470. The HTML files 470 include a command script 480, which could be for example JavaScript, and image maps 420. HTML is a set of symbols or codes inserted in a file which is typically intended for display by an Internet browser. The markup file 470 is linked to other markup files 470 via the image maps 420. For displayed image files 410, for example, an area 430, also referred to herein as a screen area 430, of the graphical user interface display 150 is defined to be a link to another HTML file 470. If the user selects area 430, as for example by moving a mouse cursor onto that area 430 and then typically left clicking the mouse while the mouse cursor is in that area 430, the displayed HTML file 470 is replaced by that to which the area 430 of the replaced image file 410 is linked.

Thus, a demonstration program 110 of an application program 140 is typically created by first capturing screen images of the graphical user interface 150 while the application program 140 is running on the application system 101. These static images of the graphical user interface 150 are saved to image files 410. The captured images 410 are then referenced in HTML files 470. To provide a behavior to the demonstration program 110 that the user perceives to be an actual operational behavior of the graphical user interface 150, HTML image maps 420 are added to the HTML files 470 as appropriate. The image files 410 may also provide screen images of application menus containing image map 420 links which cause the viewing application, which is typically the web browser, to load other HTML pages 470 that contain references to images of the graphical user interface 150 which would appear under the real application graphical user interface 150. This addition gives the user the feeling that the graphical user interface 120 is actually accepting user input, and taking the appropriate action based on that input when in fact the demonstration program 110 is stepping from one static screen image to another under precise and limited conditions.

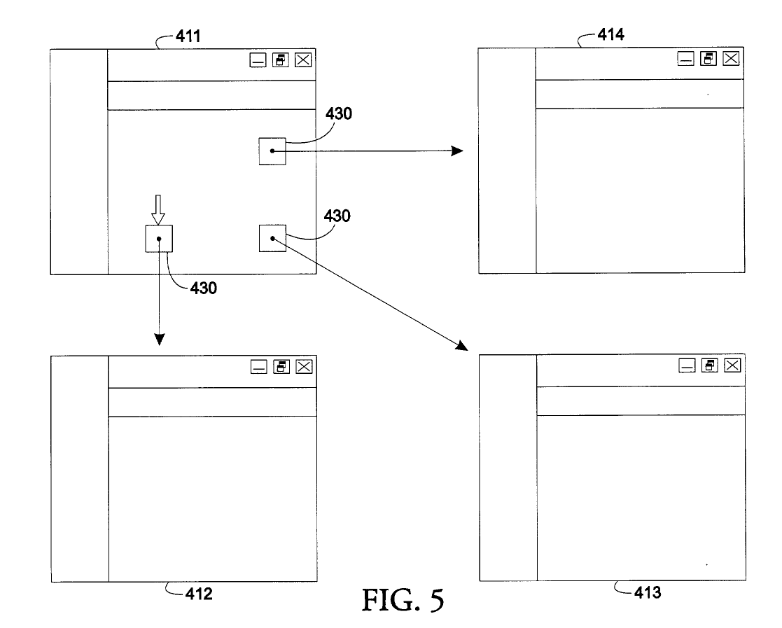

FIG. 5 is a drawing illustrating the contents of the markup files 470 with linking image maps 420 and image files 410 as described in various representative embodiments consistent with the teachings of the invention. In FIG. 5, mouse clicking on areas 430 on the stored first graphical image interface 411 provides links via image maps 420 to second, third, and fourth graphical user interface images 412,413,414.

The linked graphical user interface images 412,413,414 of FIG. 5 may also be screen images that contain drop-down menus such as the File menu. In this example, when the user of the demonstration program 110 clicks on the File area of the screen, a new image is displayed that contains the original graphical user interface image 411 with the addition of the drop-down menu for that part of the image. The user can then click on any of the menu items displayed. These menu items are linked to other appropriate screens, so that when the user clicks on those menu items, he is given the impression that the menus work as they actually do in the application program 140. However, the creator of the demonstration program 110 may also choose, for whatever reason, not to link certain areas, including menu selections which would be active in the application program 140, to other screens.

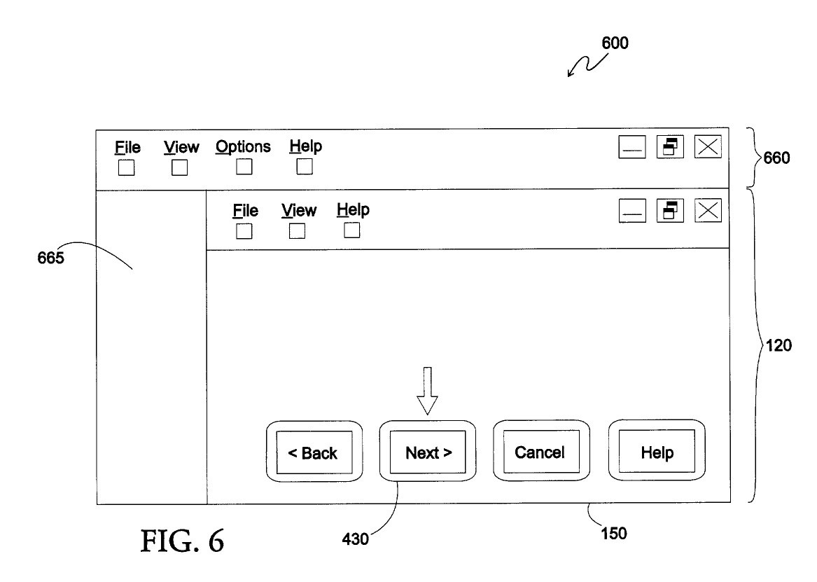

FIG. 6 is a drawing of a user program interface 600 as described in various representative embodiments consistent with the teachings of the invention. In the embodiment of FIG. 6, the user program could be, for example Netscape, Microsoft Internet Explorer, or the like, having a network browser graphical user interface 600. The user program interface 600 is used to display the graphical user interface 120 of the demonstration program 110. The demonstration program graphical user interface 120 comprises a snapshot of the application program graphical user interface 150. In addition, in some representative embodiments the user program interface 600 further comprises a demonstration toolbar 660, and in other representative embodiments the demonstration program graphical user interface 120 further comprises a guide window 665, also referred to herein as a sub-window 665. The guide window 665 preferably comprises instructions to the user regarding steps to follow in completing the demonstration of the application program 140, as well as any other information regarding the program.

Thus, accompanying the screen shots of the application program graphical user interfaces 150 is an instructional guide in the guide window 665. The guide window 665 comprises step-by-step instructions designed not only to guide the user through the operation of the demonstration program 110, but also to act as a tutorial for the application program 140. The guide 665 provides the user the flexibility to reroute the demonstration experience, enabling the user to choose that aspect of the demonstration with which he wishes to interact.

The resultant embodiment is a set of HTML pages 470 with image maps 420 and references to screen shots 410 with a detailed instructional guide which aids the user throughout the demonstration and gives him the feel of the product. This combination provides the user with a realistic view of the graphical user interface and the application program 140 without the overhead of an actual application program 140 running on the user's platform.

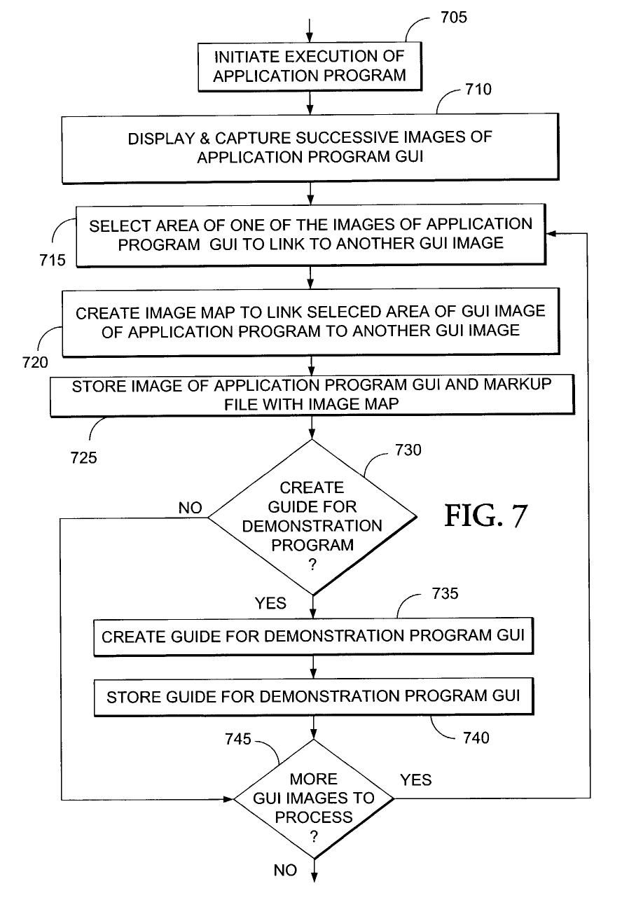

FIG. 7 is an illustrative flow chart of a method for creating a demonstration program 110 as described in various representative embodiments consistent with the teachings of the invention. In block 705, execution of the application program 140 is initiated on the application computer 135. Block 705 then transfers control to block 710.

In block 710, the image of the application program graphical user interface 150 is displayed and captured in image file 410. Block 710 then transfers control to block 715.

In block 715, at least one screen area 430 of the image of the application program graphical user interface 150 is selected to link to another screen of the application program graphical user interface 150. Block 715 then transfers control to block 720.

In block 720, an image map 420 within the markup file 470 is created to link the image of the application program graphical user interface 150 to another screen of the application program graphical user interface 150. Block 720 then transfers control to block 725.

In block 725, the application program graphical user interface 150 and the image map 420 contained within the markup file 470 are stored. Block 725 then transfers control to block 730.

While the a guide window 665 is to be created for the demonstration program 110, block 730 transfers control to block 735. Otherwise, block 730 transfers control to block 745.

In block 735, the guide window 665 for the demonstration program graphical user interface 120 is created. Block 735 then transfers control to block 740.

In block 740, the guide window 665 for the demonstration program graphical user interface 120 is stored. Block 740 then transfers control to block 745.

While there are more application program graphical user interfaces 150 to process, block 745 transfers control to block 715. Otherwise, block 745 terminates the process.

As is the case, in many data-processing products, the demonstration program 110 maybe implemented as a combination of hardware and software components. Moreover, the functionality required for using the invention may be embodied in computer-readable media, also referred to as program storage media, to be used in programming an information-processing apparatus, as for example a personal computer and client and server computers connected via a network 215. The term program storage medium is broadly defined herein to include any kind of computer memory such as, but not limited to, floppy disks, conventional hard disks, DVD 's, CD-ROM's, Flash ROM's, nonvolatile ROM, and RAM. The display may be monochrome or color, and a pointing device 117 such as a light pen 117, a mouse 117, a track ball 117, or a touch screen 117 that is suitable for cursor manipulation may be used.

The computers 105,135,205,210 can be capable of running any commercially available operating system such as DOS, any version of Windows, Macintosh, or other suitable operating system. The present invention can be advantageously implemented as an application program for a fixed or portable computer system, as well as one attached to a network. Such an application program can be written using a variety of programming languages including Visual Basic, C/C++, assembler or any other commercially-available programming tools.

While embodiments disclosed have been presented in terms of HTML, alternative languages, as for example the extensible markup language (XML) may also be used. In addition, programs, as for example Adobe Acrobat, which are capable of displaying images and links between images can be used equivalently in applications embodying the invention.

Representative embodiment disclosed herein allow the user to choose which screens to view, which parts of the program to explore, and which actions to perform. These embodiments combine the flexibility of allowing the user to interact with the graphical user interface while providing the tutorial sensation that the screen recording utility approach provides. Such embodiments do not necessarily incur the extensive resource costs of a full application program 140. In addition, the HTML/image map approach allows customers to interact with the graphic user interface requiring only a web browser. Also, in many cases during program execution application programs make changes to the application system. These system changes may be intrusive to other users of the application system 101. For example, HP's Partition Manager software makes changes to the application system 101 that requires a system reboot. This operation renders the system 101 unavailable for a period of time. Teachings disclosed herein provide techniques by which demonstration programs 110 are created which do not change the demonstration system 100 leaving the demonstration system 100 in a usable state.

While the present invention has been described in detail in relation to preferred embodiments thereof, the described embodiments have been presented by way of example and not by way of limitation. It will be understood by those skilled in the art that various changes may be made in the form and details of the described embodiments resulting in equivalent embodiments that remain within the scope of the appended claims.

What is claimed is:

1. A computer operable method for creating a demonstration program for an application program, wherein the demonstration program is executable on a first computer, the method comprising the steps of:
initiating the application program on a second computer;
on a monitor connected to the second computer, displaying at least two images of a graphical user interface created by the application program, wherein one of the images is selectable from the other image for display on the monitor;
capturing at least two images of the graphical user interface displayed;
creating an image map for the image of the graphical user interface from which the other image of the graphical user interface is selectable, wherein the image map specifies the linkage between the images of the graphical user interface; and
linking captured images of the graphical user interface and the image map to form the demonstration program, wherein the demonstration program mirrors the functional selectivity of one image of the graphical user interface by another in the application program.

2. The computer operable method as recited in claim 1, providing the program language used to link images of a graphical user interface of the demonstration program is selected from the group consisting of extensible markup language and hypertext markup language.

3. The computer operable method as recited in claim 1, providing the first computer is a local computer connected to a central computer via a communication link.

4. The computer operable method as recited in claim 3, providing the communication link is selected from the group consisting of a network, Internet, loopback interface, and a telephone system.

5. The computer operable method as recited in claim 3, providing the local computer is configured as a client computer and the central computer is configured as a server computer.

6. The computer operable method as recited in claim 1, providing the application program is inoperable on the first computer.

7. The computer operable method as recited in claim 1, further comprising the steps of:
creating a sub-window on a monitor of the first computer, wherein the sub-window displays information related to the demonstration program.

8. The computer operable method as recited in claim 1, wherein link between images of the graphical user interface of the demonstration program provided by the image map is selectable in the demonstration program by activating a computer pointing device on a defined area of the image of the graphical user interface in the demonstration program.

9. The computer operable method as recited in claim 1, wherein the computer pointing device is selected from the group consisting of a light pen, a computer mouse, a track ball, and a touch screen.

10. A program storage medium readable by a computer, embodying a software program of instructions executable by the computer for creating a demonstration program for an application program, wherein the demonstration program is executable on a first computer, the program comprising:
logic, for initiating the application program on a second computer;
logic, for on a monitor connected to the second computer, displaying at least two images of a graphical user interface created by the application program, wherein one of the images is selectable from the other image for display on the monitor;
logic, for capturing at least two images of the graphical user interface displayed;
logic, for creating an image map for the image of the graphical user interface from which the other image of the graphical user interface is selectable, wherein the image map specifies the linkage between the images of the graphical user interface; and
logic, for linking the images of the graphical user interface and the image map to form the demonstration program, wherein the demonstration program mirrors the functional selectivity of one image of the graphical user interface by another in the application program.

11. The program storage medium as recited in claim 10, providing the program language used to link images of a graphical user interface of the demonstration program is selected from the group consisting of extensible markup language and hypertext markup language.

12. The program storage medium as recited in claim 10, providing the first computer is a local computer connected to a central computer via a communication link.

13. The program storage medium as recited in claim 12, providing the communication link is selected from the group consisting of a network, Internet, loopback interface, and a telephone system.

14. The program storage medium as recited in claim 12, providing the local computer is configured as a client computer and the central computer is configured as a server computer.

15. The program storage medium as recited in claim 10, providing the application program is inoperable on the first computer.

16. The program storage medium as recited in claim 10, further comprising the steps of:
logic, for creating a sub-window on a monitor of the first computer, wherein the sub-window displays information related to the demonstration program.

17. The program storage medium as recited in claim 10, wherein link between images of the graphical user interface of the demonstration program provided by the image map is selectable in the demonstration program by activating a computer pointing device on a defined area of the image of the graphical user interface in the demonstration program.

18. The program storage medium as recited in claim 17, wherein the computer pointing device is selected from the group consisting of a light pen, a computer mouse, a track ball, and a touch screen.
